(19) United States
(12) Patent Application Publication
(10) Pub. No.: US 2017/0322776 A1
(43) Pub. Date: Nov. 9, 2017

(54) PRODUCT LIFECYCLE MODEL INCLUDING SOFTWARE DEVELOPMENT

(71) Applicant: SAP SE, Walldorf (DE)

(72) Inventor: Jens Griessmann, Walldorf (DE)

(21) Appl. No.: 15/145,506

(22) Filed: May 3, 2016

(51) Int. Cl. G06F 9/44; G06F 3/0484

(52) U.S. Cl. CPC G06F 8/20; G06F 3/04842

(57) ABSTRACT

Provided are a device and method for displaying a product in a product lifecycle management (PLM) system. In some embodiments, the device may include an input unit that may receive input from a user, a processor that may generate an engineering model of a product corresponding to one or more physical components of the product, and generate a software model of the product corresponding to one or more software components of the product, and a display that may display representations of both the engineering model and the software model incorporated in a same window.

### BACKGROUND

Product lifecycle management (PLM) is a systematic approach for managing the series of changes a product goes through, from its design and development to its ultimate retirement or disposal. PLM (or a PLM software application) can help an organization manage a product's lifecycle by providing data for information that affects the product. PLM software can be used to automate the management of product-related data and integrate the data with other management processes such as enterprise resource planning (ERP) and manufacturing execution systems (MES). One of the goals of PLM is to reduce waste and improve efficiency. At the core of PLM is its ability to serve in the development and central management of product data and technology used to access product data. PLM uses tools such as computer-aided design (CAD), computer-aided manufacturing (CAM), product data management (PDM), and the like. A well maintained PLM system can act as a central information hub and streamline product development and facilitate easier communication among those working on a product.

Due to the increasing capabilities and more affordable costs of electronic components, software for controlling such components has become widespread in many types of products. One type of software used in everyday products is embedded software. Product makers use embedded software to control the functions of various hardware devices and systems within the product. Embedded software may control device functions in the same way that a computer's operating system controls the function of software applications. Almost any device can contain embedded software including those so simple you might not imagine they had computer control, like coffee machines and toasters, to more complex systems such as missiles, automobiles, and airplanes.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings, in which:

FIG. 1 is a diagram illustrating an overview of a product lifecycle management system incorporating software development in accordance with an example embodiment.

FIGS. 2A and 2B are diagrams illustrating a product model including a representation of both an engineering model and a software model incorporated together in accordance with an example embodiment.

FIG. 3 is a diagram illustrating a hierarchical relationship between product components in accordance with an example embodiment.

FIG. 4 is a diagram illustrating a process of handing over the product model to manufacturing in accordance with an example embodiment.

FIG. 5 is a diagram illustrating a computing device for performing product lifecycle management in accordance with an example embodiment.

FIG. 6 is a diagram illustrating a method for performing product lifecycle management in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

According to various examples provided herein, a product lifecycle management (PLM) system may be used to develop and manage physical components and software components of a product within the same window or user interface. For example, the PLM system may manage electrical and mechanical components of a product side-by-side or in parallel with the software components of the product using the PLM system. In some examples, even if a software component has a different lifecycle than a physical component of the product, the PLM system herein can be used to manage both. Accordingly, the importance and volume of software in nearly all kind of products may be reflected in the engineering, development and manufacturing of the product within the PLM system. For example, software may be established next to mechanical computer-aided design (mCAD) and electrical computer-aided design (eCAD) development as a third discipline within the product lifecycle management of a product in the examples herein.

In some examples, an application lifecycle management (ALM) of product software itself and its version based development cycles may be incorporated with the lifecycle management of mechanical and electrical components of the product. For example, the ALM of software may be implemented in the PLM world taking into account the higher development rates of versions for software compared to a slower development rate for physical parts having much shorter lifecycles. The PLM may also include compatibility of different software (and its different versions) with respect to electronic and mechanical components, and a configuration of software to match the needs for system functionalities. In these examples, logistics and delivery of software may be implemented together with the physical components of the product or may be implemented separately such as through download services pulled from a customer side.

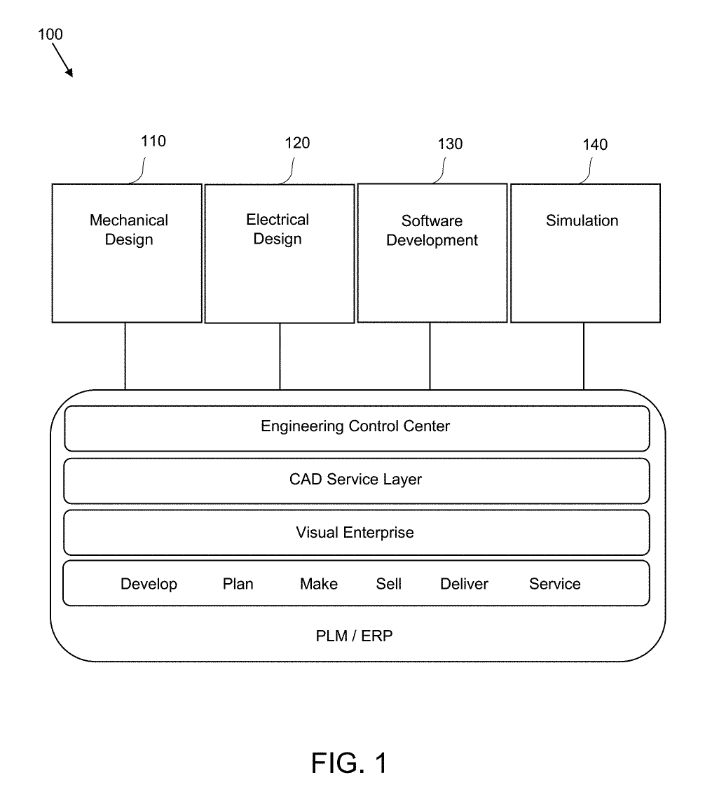

FIG. 1 illustrates an overview 100 of a product lifecycle management platform incorporating software development in accordance with an example embodiment. Referring to FIG. 1, the overview 100 includes one platform with authoring tool interfaces for mechanical design 110, electrical design 120, and software development 130. The platform also includes a simulation option 140. Overall, the importance and the amount of software in many types of products is increasing and needs to be reflected in the engineering, development, and manufacturing of the product. In this example, software development 130 is established next to and in parallel with mechanical design 110 (such as mCAD) and electrical design 120 (such as eCAD) and is integrated within the product lifecycle management of the product. Accordingly, an application lifecycle management (ALM) of the software and its version may be compared to and incorporated along with development cycles of components in the lifecycle management of the mechanical design 110 and the electrical design 120.

A product model that results from using the PLM framework shown in FIG. 1 may include a representation of the mechanical design, the electrical design, and the software design, incorporated together. For example, the product model may include an integration of the ALM of the software in the PLM of the physical components and also take into account the faster development rates of software versions compared with physical parts of the product. The product model may also include an indication of whether different software versions are compatible with the product at a particular lifecycle of the product. The product model may also include a configuration of software to match the needs of the system functionalities. In the example of FIG. 1, the mechanical design 110, the electrical design 120, and the software development 130 may be controlled though an engineering control center and may use various services such as computer-aided design (CAD) services to generate the product model. The resulting product model may include information about various stages of the product including development, planning, making, selling, delivering, and servicing. The resulting PLM or enterprise resource planning (ERP) may be used to collect, store, manage, and interpret data for the product model.

Also included in FIG. 1 is a simulation option 140. The simulation option 140 may be performed next to or in parallel with the software development and the physical development of the product and may provide a simulation or test environment for software components in combination with physical components of the product. In addition, the simulation 140 may include functional test results gained from the authoring disciplines in early product development phases. In order for a product to be successful, the software of the product needs to be compatible with the hardware, otherwise there will be a need for continuing product updates or potential product failure. Using the simulation 140, functionality of the product may be verified at each and every phase of engineering and development, and may be performed at a component level, a product level, and the like. The simulation 140 may support testability and requirement fulfillment checks of the product. Therefore, rather than test the product after the physical components have been completed and the software components have been completed, the physical components and the software components can be tested at each step along the way prior to completion of the final as-built product.

The PLM platform shown in FIG. 1 may serve the needs of current product development in which software has become an increasingly more important role. The PLM platform may be useful not just for computing industries, but also mechanical products which use software to control various physical components. The platform is capable of allowing a user to simultaneously interact with three domains, mechanical, electrical, and software design. Normally each of the engineers remain in their separate discipline (mechanical, electrical, and software) and perform independent testing of their domain of the product without incorporation of the design from the other domains. However, the example embodiments provide a more efficient way of testing the lifecycle of a product including the early development phases by incorporating software development together with the development of the mechanical and/or electrical designs. The PLM platform that is shown in FIG. 1 may manage both hardware and software of a product. For example, the PLM platform may manage the entire lifecycle of a product (physical) from its conception, through design and manufacture, to service and disposal. The PLM platform may also manage the software (e.g., embedded software) as published from ALM to PLM and as to be used in the overall product. The resulting values provided by the PLM may include data that can be automatically converted into actionable information that can then be used for improved decision making at all levels of product development. For example, PLM provides values derived from data obtained from engineering, quality, project management, and the like, of physical and software based components.

In some examples, a next software version may occur much more frequently than a next version of mechanical and/or electrical components of a product. The platform according to various examples is capable of providing a common product model where software versions (and lifecycles thereof) are easily integrated without having changes to the mechanical and electrical portions of the product model. For example, the platform may not incorporate the changes manually in the system but may instead enhance the product model by bringing in software including new versions of software without changing the product structure of the overall mechanical/electrical version of the product model. The resulting product model may include a combination of software and mechanical parts that serve the needs of all the tests for each of the three domains. Also, it may be difficult to evaluate what is the best software version while the product is still in the production line. Accordingly, the product model described in various examples allows for the software components to be flexible for the product you are going to produce by including multiple versions and/or multiple software components for a given task.

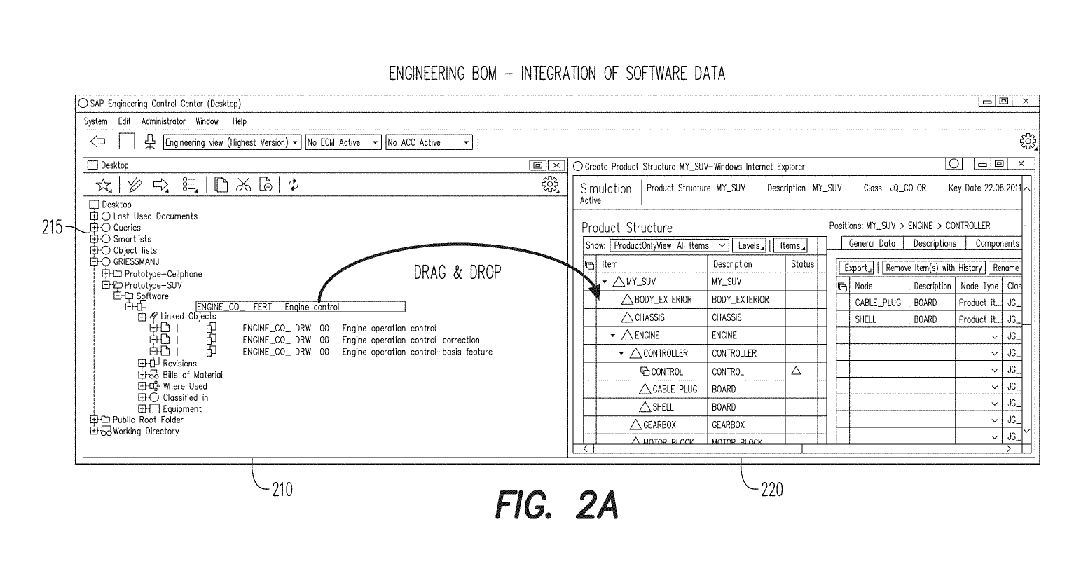

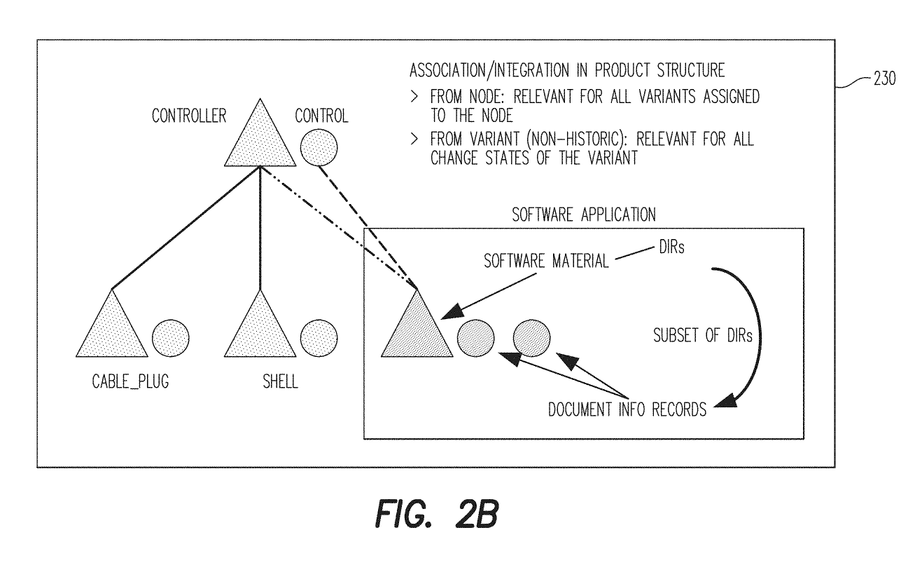

FIGS. 2A and 2B illustrate a product model including a representation of both an engineering model and a software model incorporated together in accordance with an example embodiment. Referring to FIG. 2A, the product model includes a window 210 representing both software components and physical components of the product within the same window 210. In this example, the physical (i.e., electrical and/or mechanical) components of the product and the software components of the product may be represented together within a list 215 shown in the window 210. When creating the product, or adding, deleting, editing, or otherwise controlling parts/components in the list 215, a second window 220 may be used to retrieve parts that have been predefined. For example, the user may select a component from the list 215 included in the window 210, and open the component in the second window 220 using a drag and drop operation, and the like. While in the second window 220, the user may add, delete, or change parts of the selected component and simulate those changes to determine compatibility.

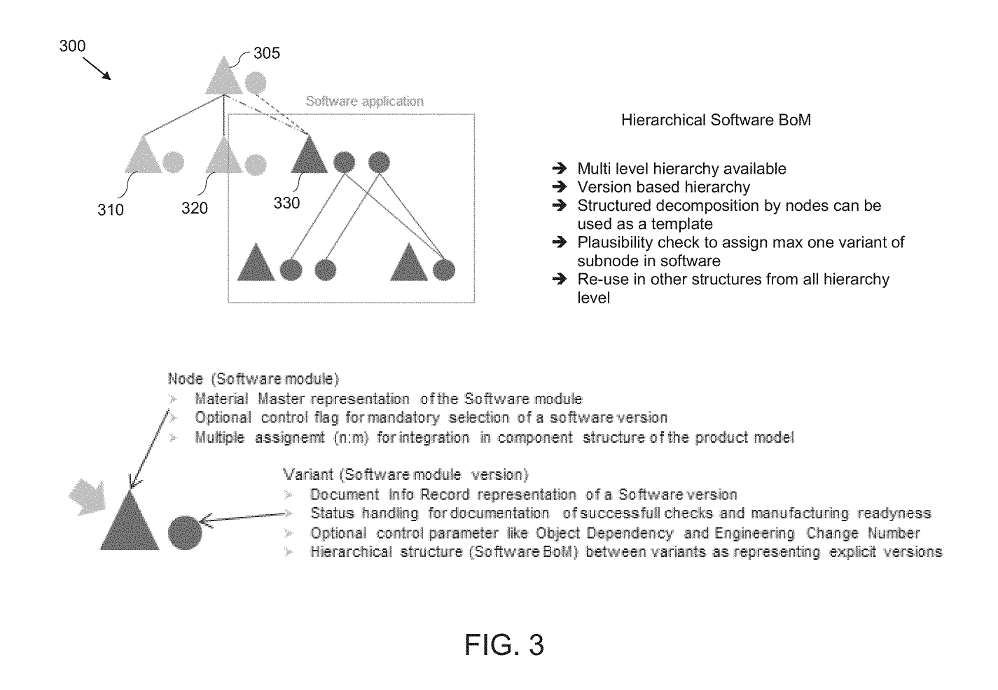

In this example, repositories for electrical, mechanical, and software design components may be present in a PLM database of the PLM. When a user wants to extend the product model the user may bring in the software as the additional component, for example, by dragging and dropping the software component instead of typing thereby allowing the product model to be extended smoothly and efficiently. Additional data can be added by user or it can be predetermined by the system. In FIG. 2B, window 230 illustrates an example of a hierarchical relationship between components in the product model. In this example, a controller component is extended by a user to include both physical and software components. The left two nodes in the hierarchy underneath the controller node represent physical parts while the right node extends the controller to include a newly added software part. For example, the software part may correspond to an embedded software component. A further example of a hierarchical relationship between product parts is shown in FIG. 3.

Referring to FIG. 3, a hierarchical relationship 300 is shown which includes a root node 305 and a plurality of child nodes 310, 320, and 330. In this example, the hierarchical relationship 300 represents various objects of a product. For example, root node 305 may correspond to the overall product or a sub-component thereof, and the nodes may correspond to products, parts, assemblies, components, and the like of the product, which may be referred to broadly herein as a component or object. The hierarchy of nodes may include descriptions of parts, features, assemblies, geometries, and others. The engineering view in the example of FIG. 3 may represent the engineering design intent or the product as actually built. In this case, the as-built product may deviate from the engineering design intent. Each node in the hierarchical representation 300 may include a set of textual data and relations between the other nodes. Data may include technical data related to the products and may be representative of products and processes.

In the example of FIG. 3, the root node 305 may correspond to an overall product structure while node 310 may correspond to a mechanical component, node 320 may correspond to an electrical component, and node 330 may correspond to a software component. That is, the hierarchical relationship 300 in this example may include a product structure having representations of both the physical components and the software components incorporated together. For example, the mechanical node 310 and the electrical node 320 may be referred to as the physical components (or an engineering model). Meanwhile, the software node 330 may be referred to as the software components (or a software model). Each node such as nodes 305, 310, 320, and 330 may include one or more child nodes. Also, the bottom of FIG. 3 illustrates an example of a software node included in the overall product structure. The node may include a master representation of a software component, and information about the compatibility of the software component with the physical components of the product.

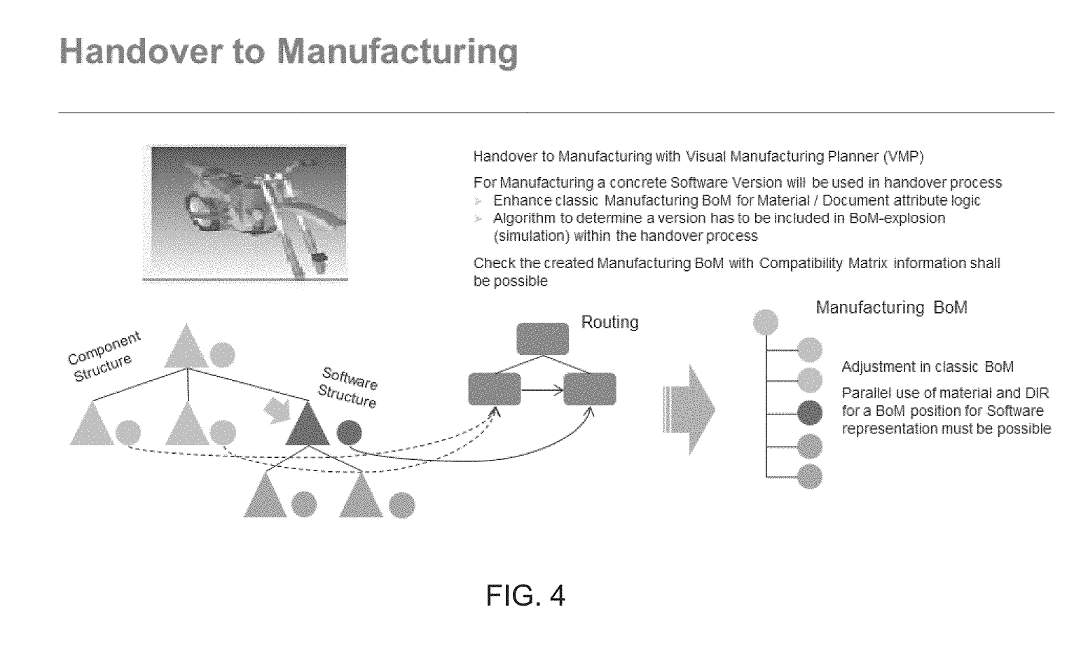

FIG. 4 illustrates a process of handing over the product model to a manufacturing side for building the product in accordance with an example embodiment. Referring to FIG. 4, the product model may include physical components and software components incorporated together and designed/engineered using a PLM application according to the example embodiments. During the manufacture of the product a concrete version of the software may be generated in combination with the physical components of the product. By incorporating software into the product model, the classic bill of materials may be enhanced, and an algorithm may be performed to determine which version of the software works best with the overall product design. Accordingly, different software versions from different lifecycle stages may be tested with the finished physical product to determine which lifecycle version is the best software for manufacturing of the product.

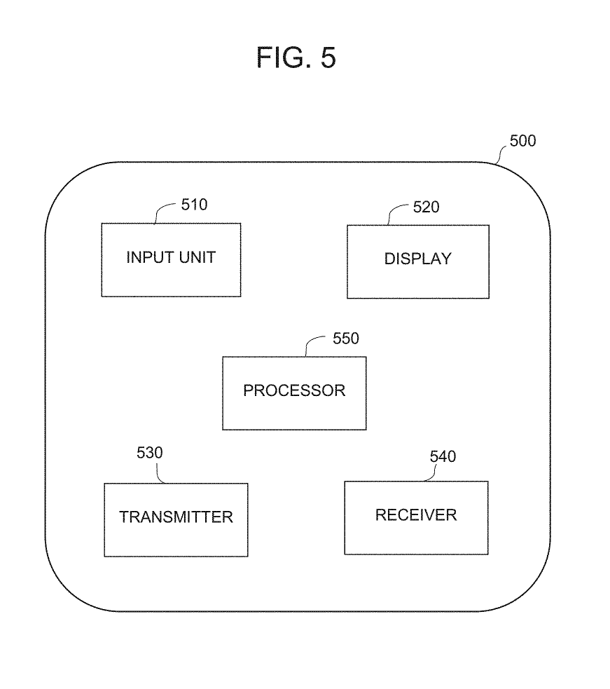

FIG. 5 illustrates a computing device 500 for performing product lifecycle management in accordance with an example embodiment. Referring to FIG. 5, the computing device 500 includes an input unit 510, a display 520, a transmitter 530, a receiver 540, and a processor 550. The input unit 510 may include any known components for receiving user input, for example, a mouse, a keyboard, keypad (actual or virtual), motion detector, speech recognizer, and the like. The transmitter 530 and the receiver 540 may transmit and receive data, for example, through a wired or wireless connection. The transmitter 530 and the receiver 540 may correspond to a network interface capable of transmitting and receiving data over a network such as the Internet, a radio interface capable of transmitting and receiving data through radio signals, and the like. Also, it should be appreciated that the computing device 500 may include additional components not shown in FIG. 5, or may not include all of the components shown in FIG. 5.

The computing device 500 may be a workstation or mobile device connected to a product lifecycle management server or other type of centralized back-end. For example, the computing device 500 may be a computer, a laptop, a mobile phone, a tablet, a laptop, and notebook, a phablet, a smart device, an appliance, and the like. During operation, the computing device 500 may access data stored on the server, database, and the like, through a product lifecycle management (PLM) software. A user of the computing device 500 may input commands through the PLM software to generate a product model of a product and store the product model on the central server. In this case, the input unit 510 may receive commands from the user and transmit the commands to the server. The processor 550 may control the product model via a window displayed on the display 520 of the computing device to generate, engineer, manufacture, design, edit, or otherwise control the product model to include any desired number of hardware or software components, parts, and the like.

According to various examples, the processor 550 may generate an engineering model of a product. In this case, the engineering model may be a portion of the product model corresponding to one or more physical components of the product such as one or more electrical components and mechanical components of the product. The engineering model may include at least one of a computer-aided design (CAD) output, a computer-aided manufacturing output, a computer-aided engineering (CAE) output, and the like. The processor 550 may also generate a software model of the product based on the development of the software. The software model may be a portion of the product model corresponding to one or more software components of the product such as embedded software components. According to various examples herein, the processor 550 may also combine the engineering model and the software model into a single product model shown within a single window on a screen of the display 520. For example, the window may be or may be included within a bill of materials (BoM) window.

For example, the processor 550 may generate an interface shown on the display 520 which allows the user to simultaneously develop, generate, design, engineer, edit, manufacture, etc., the engineering model of the product and the software model of the product. As a result, the software model may include lifecycle management of software components of the product and the engineering model may include lifecycle management of physical components of the product. Accordingly, the display 520 may display a representation of the lifecycle management of the software components incorporated with the lifecycle management of the physical components of the product in the same window. Furthermore, the software model and the engineering model may have a plurality of lifecycle stages, and a lifecycle stage of the engineering model may be of a different length of time (e.g., much longer) than a lifecycle stage of the software model.

According to various examples, the user may view and edit components of the engineering model and the software model in the same window such as a BoM window. The user may add new parts, update parts with newer versions, change parts, delete parts, and the like. For example, the user may add new software components, electrical components, and mechanical components through a drag-and-drop operation, and the like. Also, the user may test components of the engineering model and the software model in the same window. For example, the window may include a simulation option which when selected by the user simulates the functionality of a software component of the software model in combination with a physical component of the engineering model. Accordingly, a user can view whether a software component is compatible with a product. Also, the user can test multiple different versions of the software component and determine whether each version of the software component is compatible, which version works best, and which versions are not compatible.

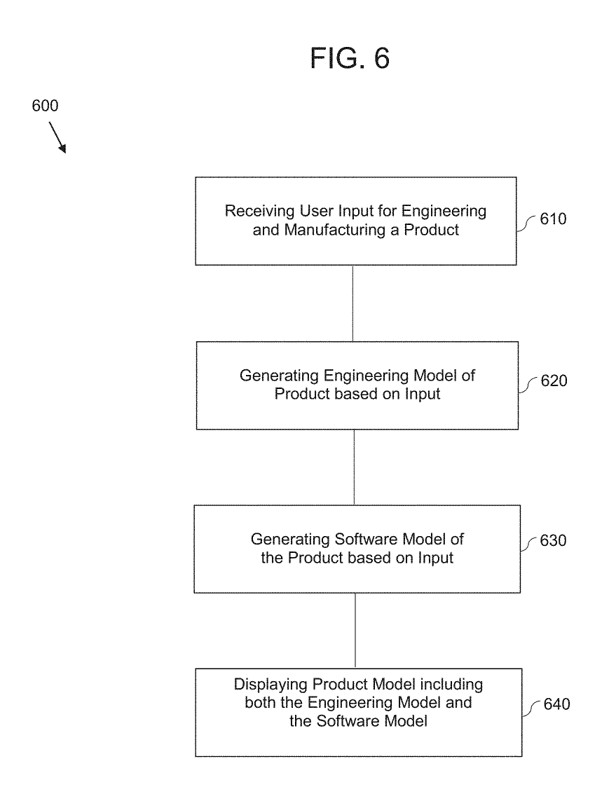

FIG. 6 illustrates a method 600 for performing product lifecycle management in accordance with an example embodiment. The method 600 of FIG. 6 may be performed by, for example, the computing device 500 shown in FIG. 5. Referring to FIG. 6, the method 600 includes receiving user input for engineering and/or manufacturing a product in 610. For example, a user interface of a PLM application may be displayed at a workstation of a user such as at computing device 500, and the user may interact with the user interface to generate, construct, or otherwise build a product model including a representation of electrical components, mechanical components, and software components of the product incorporated into a single user interface. The user may perform various inputs such as character entry, point-and-click, drag-and-drop, and the like, within the user interface to add or create components, parts, and the like, within the product model.

In 620, the method includes generating an engineering model of a product and in 630 the method includes generating a software model of the product. In this example, the engineering model may correspond to one or more physical components of the product, for example, mechanical components, electrical components, and the like. Also, the software model may correspond to one or more software components of the product, for example, embedded software and the like. In 640, the method includes displaying a product model including representations of both the engineering model and the software model incorporated together. For example, the product model may be a bill of materials, and the like. The product model may include the engineering model and the software model within the same window on a display of a workstation. As an example, the product model may include a representation of a product lifecycle management of one or more software components incorporated with a product lifecycle management of one or more physical components of the product, within the same window.

Although not shown in FIG. 6, the method 600 may further include displaying a simulation option with the product model on a screen of a workstation. When selected, the simulator option may simulate functionality of the product model including simulating functionality of one or more software components of the software model in combination with one or more physical components of the engineering model. Also, a lifecycle of a software component may be different than a lifecycle of a hardware component. For example, the software lifecycle may be shorter or longer than the hardware component. The example embodiments may identify the different lifecycles of the software component and the hardware component with the product model.

According to various example embodiments, described herein is a system and method for generating a product model that includes modeling of hardware components and software components together within the same model. By incorporating the physical components and the software components during engineering and design of the overall product, the physical design and the software design may share information and may be more efficiently designed. The product model may further include information about how the software components interact with the hardware components at each lifecycle stage of the hardware and of the software. Furthermore, the product may be tested at each stage rather than only at the end of the designing process. Accordingly, a more efficient product model may be generated by incorporating the software development of the product with the physical development.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the invention as set forth in the appended claims.

What is claimed is:

1. A computing device for displaying a product in a product lifecycle management (PLM) system, the computing device comprising:
an input unit configured to receive input from a user;
a processor configured to generate an engineering model of a product, the engineering model corresponding to one or more physical components of the product, and generate a software model of the product, the software model corresponding to one or more software components of the product; and
a display configured to display a product model including representations of both the engineering model and the software model incorporated together.

2. The computing device of claim 1, wherein the software model corresponds to an embedded software component that is embedded within the product.

3. The computing device of claim 1, wherein the software model corresponds to a product lifecycle management of a software component of the product,
the engineering model corresponds to a product lifecycle management of a physical component of the product, and
the display is configured to display the product model to include a representation of the product lifecycle management of the software component incorporated with the product lifecycle management of the physical component of the product incorporated together.

4. The computing device of claim 1, wherein the processor is configured to generate the engineering model and the software model based on input from the user received through the input unit.

5. The computing device of claim 1, wherein the software model and the engineering model each have a plurality of lifecycle stages, and a lifecycle stage of the engineering model has a different length of time than a lifecycle stage of the software model.

6. The computing device of claim 1, wherein the product model comprises a bill of materials (BOM) including representations of both the engineering model and the software model incorporated together.

7. The computing device of claim 1, wherein the display is further configured to display a simulator option which when selected by the user is configured to simulate functionality of a software component of the software model in combination with a physical component of the engineering model.

8. The computing device of claim 1, wherein the engineering model corresponds to at least one electrical component of the product and at least one mechanical component of the product.

9. The computing device of claim 1, wherein the engineering model comprises at least one of a computer-aided design (CAD) output, a computer-aided manufacturing output, and a computer-aided engineering (CAE) output.

10. A method for displaying a product in a product lifecycle management (PLM) system, the method comprising:
generating an engineering model of a product, the engineering model corresponding to one or more physical components of the product,
generating a software model of the product, the software model corresponding to one or more software components of the product; and
displaying a product model including representations of both the engineering model and the software model incorporated together.

11. The method of claim 10, wherein the software model corresponds to an embedded software component that is embedded within the product.

12. The method of claim 10, wherein the software model corresponds to a product lifecycle management of a software component of the product,
the engineering model corresponds to a product lifecycle management of a physical component of the product, and
the displaying comprises displaying the product model to include a representation of the product lifecycle management of the software component incorporated with the product lifecycle management of the physical component of the product.

13. The method of claim 10, wherein the generating of the engineering model and the software model is performed based on input from a user.

14. The method of claim 10, wherein the software model and the engineering model each have a plurality of lifecycle stages, and a lifecycle stage of the engineering model has a different length of time than a lifecycle stage of the software model.

15. The method of claim 10, wherein the product model comprises a bill of materials (BOM) including representations of both the engineering model and the software model incorporated together.

16. The method of claim 10, wherein the displaying further comprises displaying a simulator option which when selected by a user is configured to simulate functionality of a software component of the software model in combination with a physical component of the engineering model.

17. The method of claim 10, wherein the engineering model corresponds to at least one electrical component of the product and at least one mechanical component of the product.

18. The method of claim 10, wherein the engineering model comprises at least one of a computer-aided design (CAD) output, a computer-aided manufacturing output, and a computer-aided engineering (CAE) output.

19. A non-transitory computer readable medium having stored therein instructions that when executed cause a computer to perform a method for displaying a product in a product lifecycle management (PLM) system, the method comprising:
generating an engineering model of a product, the engineering model corresponding to one or more physical components of the product,
generating a software model of the product, the software model corresponding to one or more software components of the product; and
displaying a product model including representations of both the engineering model and the software model incorporated together.

20. The non-transitory computer readable medium of claim 19, wherein the software model corresponds to a product lifecycle management of a software component of the product,
the engineering model corresponds to a product lifecycle management of a physical component of the product, and
the displaying comprises displaying a representation of the product lifecycle management of the software component incorporated with the product lifecycle management of the physical component of the product.
